(19) United States
(12) Patent Application Publication
(10) Pub. No.: US 2026/0149272 A1
(43) Pub. Date: May 28, 2026

(54) INTEGRATED DC GENSET

(71) Applicant: SCHNEIDER ELECTRIC IT CORPORATION, Foxboro, MA (US)

(72) Inventors: Wedian Youssef, Bernin (FR); Daniel Radu, Montbonnot Saint Martin (FR)

(21) Appl. No.: 18/962,054

(22) Filed: Nov. 27, 2024

(51) Int. Cl. H02J 1/12; H02M 7/00; H02M 7/08; H02M 7/10

(52) U.S. Cl. CPC H02J 1/12; H02M 7/003; H02M 7/08; H02M 7/10; H02J 2101/20; H02J 2105/425

(57) ABSTRACT

Examples of the disclosure include a power-distribution system, comprising a high-voltage input, a high-to-medium voltage transformer coupled to the high-voltage input, a medium-to-low voltage transformer coupled to the high-to-medium voltage transformer, a generator, a low-voltage switchgear coupled to the generator, the low-voltage switchgear being configured to receive input DC power derived from the generator and to output DC power to information technology (IT) equipment, and a first AC-DC converter coupled between the medium-to-low voltage transformer and the low-voltage switchgear.

### BACKGROUND

### 1. Field of the Disclosure

At least one example in accordance with the present disclosure relates generally to power distribution.

### 2. Discussion of Related Art

Data centers may include a large number of electrical loads. Example loads include servers and associated equipment, such as uninterruptible power supplies to provide power to the servers, cooling equipment to cool the servers, and so forth. A data center may include power-distribution equipment to provide power to the electrical loads.

### SUMMARY

Examples of the methods and systems discussed herein are not limited in application to the details of construction and the arrangement of components set forth in the following description or illustrated in the accompanying drawings. The methods and systems may be capable of implementation in other embodiments and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phraseology and terminology used herein is for the purpose of description. References to examples, embodiments, components, elements, or acts of the systems and methods herein referred to in the singular may also embrace embodiments including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer A and/or B-that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

According to at least one aspect of the present disclosure, a power-distribution system is provided, comprising a high-voltage input; a high-to-medium voltage transformer coupled to the high-voltage input; a medium-to-low voltage transformer coupled to the high-to-medium voltage transformer; a generator; a low-voltage switchgear coupled to the generator, the low-voltage switchgear being configured to receive input DC power derived from the generator and to output DC power to information technology (IT) equipment; and a first AC-DC converter coupled between the medium-to-low voltage transformer and the low-voltage switchgear.

In at least one example, the low-voltage switchgear is configured to derive the output DC power from the high-voltage input. In at least one example, the generator includes a second AC-DC converter. In at least one example, the DC generator further comprises an AC generator coupled to the second AC-DC converter. In at least one example, the second AC-DC converter is a four-diode bridge rectifier. In at least one example, the system includes a medium-voltage switchgear coupled between the high-to-medium voltage transformer and the medium-to-low voltage transformer. In at least one example, the system includes a second high-voltage input; a second high-to-medium voltage transformer; and a second medium-voltage switchgear coupled between the second high-voltage input and the medium-to-low voltage transformer.

In at least one example, the system includes a third medium-voltage switchgear coupled to the first medium-voltage switchgear, the second medium-voltage switchgear, and the medium-to-low voltage transformer. In at least one example, the low-voltage switchgear is configured to be coupled to one or more alternate DC power sources. In at least one example, the one or more alternate DC power sources include a renewable power source. In at least one example, the system includes a catcher redundancy system, the catcher redundancy system including: a second medium-to-low voltage transformer; a third AC-DC converter coupled between the second medium-to-low voltage transformer and the low-voltage switchgear; and a second DC generator including a fourth AC-DC converter configured to provide DC power to the low-voltage switchgear. In at least one example, the system includes a second low-voltage switchgear coupled to the third AC-DC converter, the fourth AC-DC converter, and the first low-voltage switchgear. In at least one example, the second low-voltage switchgear is configured to be coupled to one or more alternate DC power sources. In at least one example, the one or more alternate DC power sources include a renewable power source.

Examples of the disclosure include a power-distribution system, comprising: a high-voltage input; a high-to-medium voltage transformer coupled to the high-voltage input; a medium-to-low voltage transformer coupled to the high-to-medium voltage transformer; a medium-voltage switchgear coupled between the high-to-medium voltage transformer and the medium-to-low voltage transformer; a low-voltage switchgear configured to be coupled to a DC generator and to output DC power to information technology (IT) equipment; and an AC-DC converter coupled between the medium-to-low voltage transformer and the low-voltage switchgear.

In at least one example, the system includes a second high-voltage input; a second high-to-medium voltage transformer; and a second medium-voltage switchgear coupled between the second high-voltage input and the medium-to-low voltage transformer. In at least one example, the system includes a third medium-voltage switchgear coupled to the first medium-voltage switchgear, the second medium-voltage switchgear, and the medium-to-low voltage transformer.

Examples of the disclosure include a method of operating a power-distribution system including a high-voltage input, a high-to-medium voltage transformer coupled to the high-voltage input, a medium-to-low voltage transformer coupled to the high-to-medium voltage transformer, a low-voltage switchgear configured to be coupled to a generator and configured to output DC power to information technology (IT) equipment, and a first AC-DC converter coupled between the medium-to-low voltage transformer and the low-voltage switchgear, the method comprising: operating the low-voltage switchgear to derive output DC power from the high-voltage input to the IT equipment in a first mode of operation; and operating the low-voltage switchgear to derive output DC power from the generator to the IT equipment in a second mode of operation.

In at least one example, the power-distribution system further includes a second high-voltage input, a second high-to-medium voltage transformer, and a medium-voltage switchgear coupled to the high-voltage input, the second high-voltage input, and the medium-to-low voltage transformer, and the first mode of operation includes operating the medium-voltage switchgear to derive power from the high-voltage input. In at least one example, the method includes operating the medium-voltage switchgear and the low-voltage switchgear to derive output DC power from the second high-voltage input to the IT equipment in a third mode of operation.

### BRIEF DESCRIPTION OF THE DRAWINGS

Various aspects of at least one embodiment are discussed below with reference to the accompanying figures, which may not be drawn to scale. The figures are included to provide an illustration and a further understanding of the various aspects and embodiments and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or substantially similar component that is illustrated in various figures may be represented by a like numeral. For purposes of clarity, not every component may be labeled in every figure. In the figures:

FIG. 1 illustrates a block diagram of a power system according to an example;

FIG. 2 illustrates a block diagram of a power system according to an example;

FIG. 3 illustrates a schematic diagram of the power system of FIG. 2 according to an example;

FIG. 4 illustrates a block diagram of a power system according to another example; and

FIG. 5 illustrates a schematic diagram of the power system of FIG. 4 according to an example.

### DETAILED DESCRIPTION

As discussed above, data centers may include a large number of electrical loads and associated equipment, such as cooling equipment, power-distribution units (PDUs), rack PDUs (rPDUs), uninterruptible power supplies (UPSs), and so forth. In some examples, a data center may include a power-distribution system to distribute power from one or more sources (for example, a utility grid, a generator, a renewable energy source, or other power sources) to the large number of electrical loads.

In some examples, a primary power source may include an AC utility grid. However, utility grids may occasionally be unavailable during blackout periods. Data centers may include generators to provide backup power when acceptable grid power is unavailable. The utility grid and/or generators may distribute power to the loads via the power-distribution system. For example, the power-distribution system may include switchgears, transformers, power converters, and so forth, to distribute power from power sources to loads. Some power-distribution systems include UPSs to power the loads during a changeover period from grid power to generator power.

In some examples, utility grid and the generators may distribute AC power to the loads via the power-distribution system. Each of the loads (or a group of loads, such as a data-center rack) may receive the AC power and convert the AC power to DC power with an AC/DC rectifier. For example, each rack in the data center may include an rPDU with an AC/DC converter configured to receive the AC power from the power-distribution system, convert the AC power to DC power, and then distribute the DC power to the loads within the rPDU's corresponding rack.

Distributing AC power from an AC utility grid and/or AC generators may be inefficient. For example, the AC power provided to the loads via the power-distribution system may pass through a double-conversion UPS, a step-down PDU, a power-factor-correction circuit (PFC), and finally a converter (for example, an AC/DC converter) before being consumed by loads. Each of these components may reduce the efficiency of the system. Distributing DC power from a DC generator and/or rectified DC power provided by an AC utility grid may be more efficient. For example, the DC power provided to the loads via the power-distribution system may pass through a DC UPS and a DC/DC converter before being consumed by loads, which may be more efficient than passing through a double-conversion UPS, a step-down PDU, a PFC, and finally a DC/DC converter. Moreover, because the speed of the AC generator is constrained by the frequency of power consumed by other factors (for example, the frequency of an AC grid, which may operate at 50 or 60 Hz, for example), it may not be feasible or possible to operate an AC generator at different speeds that optimize other parameters, such as fuel consumption and/or emissions volume. Operating a DC generator may enable more flexibility in operating speed, such as by enabling the DC generator to use a smaller engine and to operate at higher speeds.

Examples of the disclosure provide a power-distribution system that operates with DC power upstream of one or more loads (for example, racks of information technology [IT] equipment in a data center). For example, a power-distribution system may include one or more AC/DC rectifiers configured to convert AC utility power to DC power and provide the DC power to a low-voltage switchgear. The low-voltage switchgear may be further configured to receive DC power from one or more DC generators. The low-voltage switchgear may distribute DC power to one or more DC loads via a busway. Accordingly, rather than implementing a power-distribution system in which AC power is distributed to one or more loads which convert the AC power to DC power at the load level, examples of the disclosure include a power-distribution system in which DC power is distributed to one or more loads.

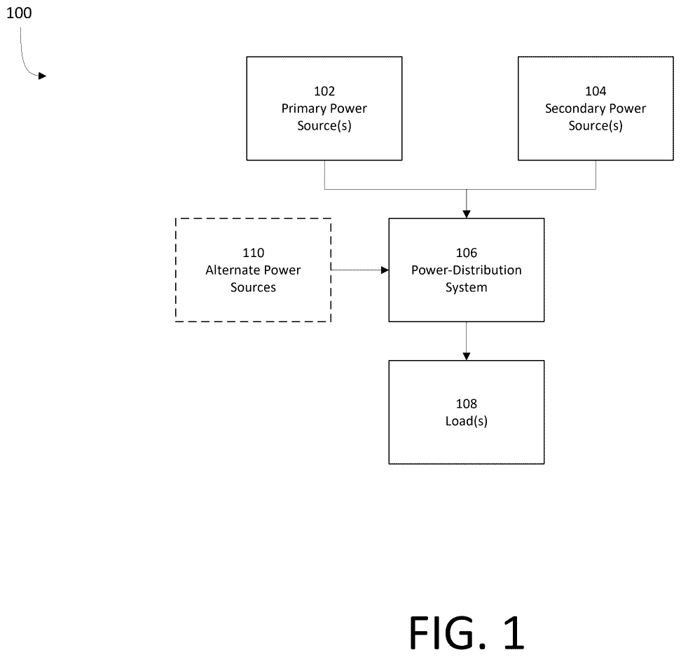

FIG. 1 illustrates a block diagram of a power system 100 according to an example. In some examples, the power system 100 may be or include a data center containing many racks of IT equipment. In other examples, however, the power system 100 may include a different type of system with one or more electrical loads. The power system 100 includes one or more primary power sources 102 (“primary power source 102”), one or more secondary power sources 104 (“secondary power source 104”), a power-distribution system 106, and one or more loads 108 (“loads 108”). In some examples, the power system 100 may optionally include one or more additional or alternate power sources 110 (“alternate power sources 110”).

The primary power source 102 is configured to provide power to the power-distribution system 106. The primary power source 102 may include, for example, an AC utility grid. In some examples, the primary power source 102 may include multiple redundant AC utility grid supplies.

The secondary power source 104 is configured to provide power to the power-distribution system 106. The secondary power source 104 may include power sources such as engine-generators (which may be referred to herein as gensets or generators in some examples), fuel cells, renewable energy sources (for example, wind turbines, solar cells, and so forth), and so forth. In some examples, the secondary power sources 104 may provide AC power to the power-distribution system 106. In other examples, the secondary power sources 104 may provide DC power to the power-distribution system 106. In at least one example, each of the secondary power sources 104 may include an AC/DC rectifier such that AC power produced by the secondary power sources 104 is converted to DC power prior to being provided to the power-distribution system 106. In another example, at least one of the secondary power sources 104 may provide AC power to the power-distribution system 106, and the power-distribution system 106 may include one or more AC/DC rectifiers to rectify the AC power. Accordingly, in various examples, the power-distribution system 106 may distribute AC or DC power.

The power-distribution system 106 is configured to receive power from the power sources 102, 104, and to provide power to the loads 108. The power-distribution system 106 may include one or more power-conditioning and/or-distribution devices, such as transformers, UPSs, switchgears, busways, and so forth. In some examples, the power-distribution system 106 may be coupled to multiple redundant power sources and may select one of the multiple redundant power sources to draw power from. In various examples, the power-distribution system 106 may provide AC power, DC power, or a combination thereof to the loads 108. In examples in which the optional alternate power sources 110 are included, the alternate power sources 110 may be coupled to, and configured to provide power to, the power-distribution system 106.

The loads 108 are configured to receive power from the power-distribution system 106 and consume the received power. In some examples, the loads 108 may include IT equipment such as equipment in a data-center rack. The loads 108 may also include associated equipment, such as rPDUs to distribute power, converters to convert the power received from the power-distribution system 106 (for example, to rectify AC power or to step DC power up or down), cooling equipment to cool the loads, battery back-up units (BBUs) to provide backup power, and so forth. The loads 108 may draw AC power, DC power, or a combination thereof from the power-distribution system 106.

The optional alternate power sources 110 may include additional power sources, such as fuel cells, renewable energy sources (for example, wind turbines, solar panels, hydroelectric sources, and so forth), and so forth. In some examples, the optional alternate power sources 110 may include DC power sources configured to provide DC power to the power-distribution system 106. In various examples, the optional alternate power sources 110 may be omitted.

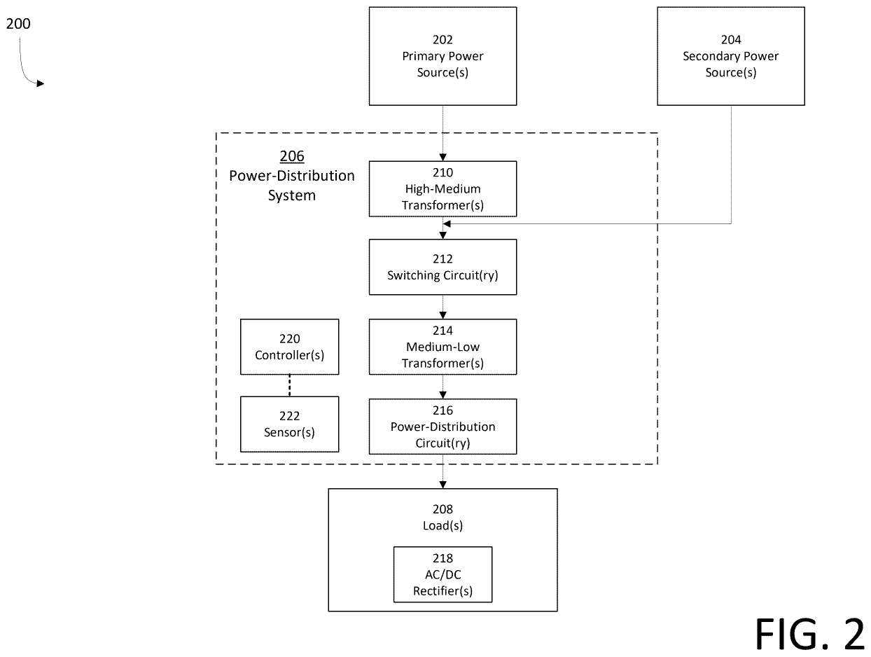

The power-distribution system 106 may be implemented in various configurations. In some examples, the power-distribution system 106 may be configured to deliver AC power to the loads 108. In other examples, the power-distribution system 106 may be configured to deliver DC power to the loads 108. The power-distribution system 106 may be configured differently based at least in part on what type of power is provided to the loads 108 and/or what type of power is received from the primary power sources 102, secondary power sources 104, and/or alternate power sources 110. Examples of the power system 100 are discussed with respect to FIGS. 2-5.

FIG. 2 illustrates a block diagram of a power system 200 according to a first example. The power system 200 may be an example of the power system 100. The power system 200 includes one or more primary power sources 202 (“primary power source 202”), one or more secondary power sources 204 (“secondary power source 204”), a power-distribution system 206, and one or more loads 208 (“loads 208”).

The primary power source 202 may be an example of the primary power source 102, and may include, for example, an AC utility grid. The secondary power source 204 may be an example of the secondary power source 104 and may include, for example, one or more AC generators. The loads 208 may be an example of the loads 108 and may include, for example, one or more units of IT equipment and/or associated equipment, such as rPDUs.

The power-distribution system 206 may be an example of the power-distribution system 106. The power-distribution system 206 includes one or more high-to-medium-voltage transformers 210 (“high-voltage transformers 210”), switching circuitry 212, one or more medium-to-low-voltage transformers 214 (“medium-voltage transformers 214”), and power-distribution circuitry 216.

In some examples, each of the loads 208 (or a group of loads) includes one or more AC/DC rectifiers 218. In alternate examples, the power-distribution system 206 may include the AC/DC rectifiers 218. For purposes of explanation, the AC/DC rectifiers 218 are described as components of the loads 208. Each of the AC/DC rectifiers 218 may include one or more components to rectify AC power to DC power, such as a four-diode-bridge rectifier.

In at least one example, the power-distribution system 206 includes at least one controller 220 (“controller 220”) to control operation of one or more components of the power-distribution system 206. In alternate examples, at least one of the controllers 220 may be external to the power-distribution system 206. The power-distribution system 206 may further include one or more sensors 222 (“sensors 222”), which may include sensors such as voltage sensors, current sensors, temperature sensors, and so forth. The sensors 222 may be distributed throughout the power-distribution system 206 and may be coupled to various components of the power-distribution system 206.

When AC power is available from the primary power source 202, the primary power source 202 provides AC power to the high-voltage transformers 210. The high-voltage transformers 210 step the high-voltage AC power down to medium-voltage AC power and provide the medium-voltage AC power to the switching circuitry 212. When AC power is not available from the primary power source 202, the secondary power source 204 may be activated as a back-up power source. For example, where the secondary power source 204 includes an AC generator, the controller 220 may send a signal to the AC generator to start up. Once the secondary power source 204 is online, the secondary power source 204 provides AC power directly to the switching circuitry 212.

The switching circuitry 212 receives power from one or both of the primary power source 202 (via the high-voltage transformer 210) or the secondary power source 204 and routes power to the medium-voltage transformer 214. For example, if acceptable AC power is available from the primary power source 202, then the controller 220 may control the switching circuitry 212 to route the AC power from the primary power source 202 to the medium-voltage transformer 214. If acceptable AC power is not available from the primary power source 202, then the controller 220 may control the switching circuitry 212 to route the AC power from the secondary power source 204 to the medium-voltage transformer 214. In some examples, the controller 220 may control the switching circuitry 212 to transfer an input-power connection between the two power sources 202, 204 in an open-transition configuration.

The medium-voltage transformer 214 receives the AC power from the switching circuitry 212 and steps down the medium-voltage AC power down to low-voltage AC power. The medium-voltage transformer 214 provides the low-voltage AC power to the power-distribution circuitry 216. The power-distribution circuitry 216 may include one or more busways, UPS, switchgears, and so forth, to distribute (and, in some examples, condition by a UPS) power to the loads 208. The AC/DC rectifiers 218 may convert the AC power to DC power prior to the power being consumed by the loads 208. As noted above, the AC/DC rectifier 218 may include multiple rectifiers in some examples, each of which receives power routed through a busway from the power-distribution circuitry 216. Accordingly, in the example of FIG. 2, AC power is rectified downstream of the power-distribution circuitry 216 and may occur at the load 208 level.

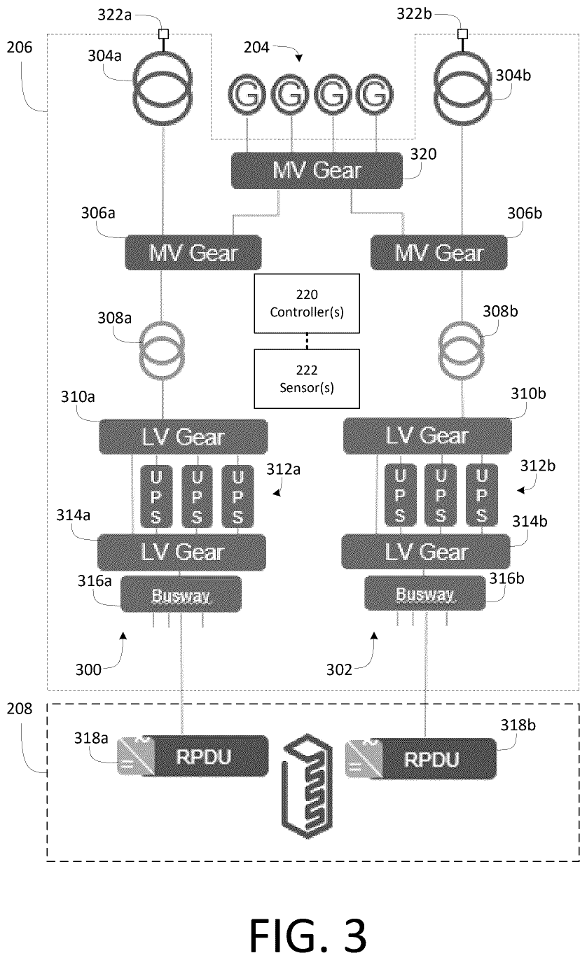

FIG. 3 illustrates a schematic diagram of the power-distribution system 206 according to an example. FIG. 3 illustrates a redundant scheme in which multiple primary power sources and multiple secondary power sources provide power to the power-distribution system 206. FIG. 3 illustrates an example of the secondary power sources 204, which includes multiple AC generators. The primary power sources 202 are not illustrated for clarity, but may include AC utility grids.

The power-distribution system 206 includes a main power path 300 and a redundant power path 302. The power-distribution system 206 may normally route power through the main power path 300. However, the power-distribution system 206 may route power through the redundant power path 302 if, for example, a component in the main power path 300 fails and needs to be replaced, needs to be maintained, needs to be upgraded, and so forth.

The main power path 300 includes a high-to-medium-voltage transformer 304a (“high-voltage transformer 304a), a medium-voltage switchgear 306a, a medium-to-low-voltage transformer 308a (“medium-voltage transformer 308a”), a first low-voltage switchgear 310a, one or more UPSs 312a, a second low-voltage switchgear 314a, and a busway 316a. In some examples, each of the loads 208 includes at least one rPDU 318a downstream of the busway 316a. Each rPDU 318a may include a respective AC/DC converter, which may include a power-factor-correction (PFC) circuit. For clarity of illustration, only one rPDU 318a associated with one load is illustrated in FIG. 3.

The redundant power path 302 includes substantially similar or identical components as the main power path 300. In one example, the redundant power path 302 includes a high-to-medium-voltage transformer 304b (“high-voltage transformer 304b”), a medium-voltage switchgear 306b, a medium-to-low-voltage transformer 308b (“medium-voltage transformer 308b”), a first low-voltage switchgear 310b, one or more UPSs 312b, a second low-voltage switchgear 314b, and a busway 316b. In some examples, each of the loads 208 includes at least one rPDU 318b downstream of the busway 316b. Each rPDU 318b may include a respective AC/DC converter. For clarity of illustration, only one rPDU 318b associated with a corresponding load is illustrated in FIG. 3. The power-distribution system 206 further includes a secondary medium-voltage switchgear 320 which is not exclusive to either of the power paths 300, 302.

The high-voltage transformer 304a is configured to be coupled to an AC-power source (not illustrated), such as an AC utility grid, at a high-voltage input 322a of the power-distribution system 206, and is coupled to the medium-voltage switchgear 306a. In at least one example, the high-voltage inputs 322a, 322b may be coupled to the secondary power sources 204, which may include one or more generators. The medium-voltage switchgear 306a is coupled to the high-voltage transformer 304a at a first input connection, to the secondary medium-voltage switchgear 320 at a second input connection, and to the medium-voltage transformer 308a at an output connection. The medium-voltage transformer 308a is coupled to the medium-voltage switchgear 306a at an input connection, and to the first low-voltage switchgear 310a at an output connection. The first low-voltage switchgear 310a is coupled to the medium-voltage transformer 308a at an input connection, and to each of the UPSs 312a at respective output connections.

Each of the UPSs 312a is coupled to the first low-voltage switchgear 310a at a respective input connection, and to the second low-voltage switchgear 314a at a respective output connection. The second low-voltage switchgear 314a is coupled to each of the UPSs 312a at respective input connections, and to the busway 316a at an output connection. The busway 316a is coupled to the second low-voltage switchgear 314a at an input connection, and is coupled to respective rPDUs (including the rPDU 318a) at respective output connections. The rPDU 318a is coupled to the busway 316a at an input connection, and is configured to be coupled to one or more loads, such as IT equipment (for example, a server rack), at an output connection.

The high-voltage transformer 304b is configured to be coupled to an AC-power source (not illustrated), such as an AC utility grid, at a high-voltage input 322b of the power-distribution system 206, and is coupled to the medium-voltage switchgear 306b. In some examples, the AC-power source to which the high-voltage transformer 304b is coupled may be the same AC-power source that the high-voltage transformer 304a is coupled to. The medium-voltage switchgear 306b is coupled to the high-voltage transformer 304b at a first input connection, to the secondary medium-voltage switchgear 320 at a second input connection, and to the medium-voltage transformer 308b at an output connection. The medium-voltage transformer 308b is coupled to the medium-voltage switchgear 306b at an input connection, and to the first low-voltage switchgear 310b at an output connection. The first low-voltage switchgear 310b is coupled to the medium-voltage transformer 308b at an input connection, and to each of the UPSs 312b at respective output connections.

Each of the UPSs 312b is coupled to the first low-voltage switchgear 310b at a respective input connection, and to the second low-voltage switchgear 314b at a respective output connection. The second low-voltage switchgear 314b is coupled to each of the UPSs 312b at respective input connections, and to the busway 316b at an output connection. The busway 316b is coupled to the second low-voltage switchgear 314b at an input connection, and is coupled to respective rPDUs (including the rPDU 318b) at respective output connections. The rPDU 318b is coupled to the busway 316b at an input connection, and is configured to be coupled to one or more loads, such as IT equipment (for example, a server rack), at an output connection. For example, the rPDU 318b may be coupled to the same one or more loads as the rPDU 318a.

The secondary medium-voltage switchgear 320 is configured to be coupled to each of the secondary power sources 204 at a respective input connection, is coupled to the medium-voltage switchgear 306a at a first output connection, and is coupled to the medium-voltage switchgear 306b at a second output connection. In at least one example, the secondary medium-voltage switchgear 320 may additionally or alternatively be coupled to one or more alternative power sources of the alternate power sources 110, which are not illustrated for clarity.

In some examples, the power-distribution system 206 may include or be coupled to the controller 220. The controller 220 is illustrated as a component of the power-distribution system 206 for purposes of example. In other examples, the controller 220 may be external to the power-distribution system 206. In various examples, the controller 220 is coupled to, and configured to control, components of the power-distribution system 206. For example, the controller 220 may control switching operation of the switchgears 306a, 306b, 310a, 310b, 314a, 314b, 320.

As discussed above, the power-distribution system 206 may include the sensors 222. The sensors 222 may be distributed throughout the power-distribution system 206 and may be coupled to various components. For example, the sensors 222 may include voltage and/or current sensors configured to sense power information at the inputs 322a, 322b, and/or at the switchgears 306a, 306b, 310a, 310b.

In operation, the controller 220 may select one of the power paths 300, 302 to deliver power to the loads 208. As discussed above, power may ordinarily be provided to the load 208 via the main power path 300. If a component in the main power path 300 needs to be replaced or maintained, then the controller 220 may control components of the power-distribution system 206 to provide power to the loads 208 via the redundant power path 302. For purposes of explanation, an example is provided in which power is provided via the main power path 300.

The controller 220 may control operation of the power-distribution system 206 based on power information received from the sensors 222. For example, the power information may be indicative of whether acceptable AC power is available at the high-voltage input 322a. In at least one example, the power information may include a voltage at the high-voltage input 322a. The controller 220 may determine whether a voltage level at the high-voltage input 322a is within a range of acceptable voltage values corresponding to acceptable AC power.

If the AC power at the input 322a is acceptable, then the controller 220 may control the medium-voltage switchgear 306a to route power received from the AC power source at the high-voltage input 322a from the high-voltage transformer 304a to the medium-voltage transformer 308a. The high-voltage transformer 304a steps down the AC power received at the high-voltage input 322a from a high voltage to a medium voltage.

If the AC power at the input 322a is not acceptable (for example, in a blackout state or with power parameters that fall outside of an acceptable range of values), then the controller 220 may control the secondary medium-voltage switchgear 320 to route power from the secondary power sources 204 to the medium-voltage switchgear 306a, and may control the medium-voltage switchgear 306a to route power to the medium-voltage transformer 308a.

The medium-voltage transformer 308a steps down the AC power received from the medium-voltage switchgear 306a from medium voltage to low voltage, and provides the AC power to the first low-voltage switchgear 310a. The controller 220 may control the first low-voltage switchgear 310a to distribute AC power from the medium-voltage switchgear 306a to the one or more UPSs 312a. The UPSs 312a may condition the power and/or provide backup power if power at the high-voltage input 322a is no longer available while the secondary power sources 204 are started up.

The UPSs 312a may provide AC power to the second low-voltage switchgear 314a. The controller 220 may control the second low-voltage switchgear 314a to provide AC power received from the UPSs 312a to the busway 316a. The busway 316a may distribute AC power to one or more connected loads 208. For example, one of the output connections of the busway 316a may provide power to the rPDU 318a. The rPDU 318a may convert the AC power to DC power, and the loads 208 may consume the power. For example, if the loads 208 include IT equipment, the IT equipment may consume the power received from the rPDU 318a.

As discussed above, the controller 220 may provide power to the loads 208 via the redundant power path 302 if, for example, a component in the main power path 300 is to be maintained or replaced. In such a circumstance, the controller 220 may control the components of the redundant power path 302 in a similar manner as the corresponding components of the main power path 300 to deliver power to the loads 208. Furthermore, as discussed above, if acceptable power is unavailable at the inputs 322a, 322b, the controller 220 may control the power-distribution system 206 to draw power from the secondary power source 204.

Accordingly, the power-distribution system 206 may receive power at the high-voltage inputs 322a, 322b and/or from the secondary power sources 204, and may provide power to the loads 208. In various examples, the power-distribution system 206 receives AC power from the inputs 322a, 322b and the secondary power sources 204, and provides AC power to the loads 208. The loads 208 may include AC/DC rectifiers in the rPDUs 318a, 318b to rectify the AC power to DC power. As discussed above, the rPDUs 318a, 318b may include PFC circuits to provide PFC to the AC power. Although the PFC circuits may provide PFC to the AC power, the PFC circuits may reduce the efficiency of the power-distribution system 206. In various examples, it may be more efficient for the power-distribution system 206 to provide DC power to the loads 208.

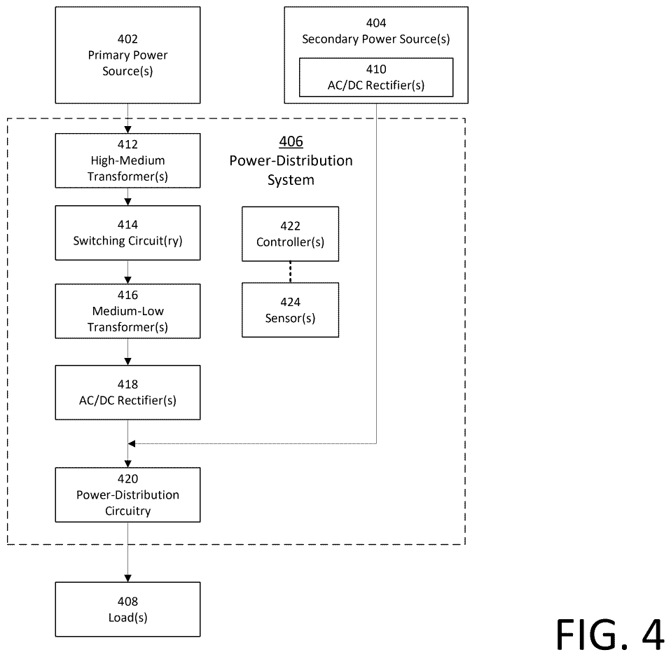

FIG. 4 illustrates a block diagram of a power system 400 according to a second example. The power system 400 may be an example of the power system 100. The power system 400 includes one or more primary power sources 402 (“primary power source 402”), one or more secondary power sources 404 (“secondary power source 404”), a power-distribution system 406, and one or more loads 408 (“loads 408”).

The primary power source 402 may be substantially similar to the primary power source 202 and may be an example of the primary power source 102. The primary power source 402 may include, for example, an AC utility grid. The secondary power source 404 may be an example of the secondary power source 104. The secondary power source 404 may be different than the secondary power source 204. For example, the secondary power source 404 may include one or more DC generators. In at least one example, each of the secondary power sources 404 may include a generator set (or genset) comprising an engine and an alternator to provide AC power. However, each of the secondary power sources 404 may further include a respective AC/DC rectifier 410 to rectify the AC power to DC power before providing the DC power to the power-distribution system 406. Accordingly, in some examples each of the secondary power sources 404 may be referred to as a DC generator. As discussed above, at least because the speed of a DC generator is not constrained by, for example, an AC grid frequency, DC generators of the secondary power sources 404 may be smaller than AC generators of the secondary power sources 204 for the same power output.

The loads 408 may be an example of the loads 108 and may be similar to the loads 208. For example, the loads 408 may include one or more units of IT equipment and/or associated equipment. However, whereas the loads 208 may be configured to receive AC power, the loads 408 may be configured to receive DC power. In various examples, the equipment associated with the IT equipment may include, for example, one or more power-supply units (PSUs) including DC/DC converters, one or more BBUs, and so forth.

The power-distribution system 406 may be an example of the power-distribution system 106. The power-distribution system 406 includes one or more high-to-medium-voltage transformers 412 (“high-voltage transformers 412”), switching circuitry 414, one or more medium-to-low-voltage transformers 416 (“medium-voltage transformers 416”), one or more AC/DC rectifiers 418, power-distribution circuitry 420, one or more controllers 422 (“controller 422”), and one or more sensors 424 (“sensors 424”), which may include, for example, one or more voltage sensors, current sensors, and/or other sensors. The sensors 424 may be distributed throughout the power-distribution system 406 and may be coupled to various components of the power-distribution system 406.

When AC power is available from the primary power source 402, the primary power source 402 provides AC power to the high-voltage transformers 412. The high-voltage transformers 412 step the high-voltage AC power down to medium-voltage AC power and provide the medium-voltage AC power to the switching circuitry 414. The switching circuitry 414 provides the AC power to the medium-voltage transformers 416. The medium-voltage transformers 416 provide the low-voltage AC power to the AC/DC rectifiers 418. The AC/DC rectifiers 418 rectify the AC power to DC power and provide the DC power to the power-distribution circuitry 420.

When AC power is not available from the primary power source 402, the secondary power source 404 may be activated as a back-up power source. For example, where the secondary power source 404 includes a DC generator, the controller 422 may send a signal to the DC generator to start up responsive to a determination that power is not available from the primary power source 402. Once the secondary power source 404 is on and ready to provide output power, the secondary power source 404 provides DC power directly to the power-distribution circuitry 420.

The power-distribution circuitry 420 receives power from one or both of the primary power source 402 (via the components 412-418) or the secondary power source 404 and routes power to the loads 408. For example, if acceptable AC power is available from the primary power source 402, then the controller 422 may control the power-distribution circuitry 420 to route the DC power received from the AC power of the primary power source 402 to the loads 408. If acceptable AC power is not available from the primary power source 402, then the controller 422 may control the power-distribution circuitry 420 to route the DC power from the secondary power source 404 to the loads 408. The power-distribution circuitry 420 may include one or more busways, switchgears, and so forth, to distribute (and, in some examples, condition by a UPS) power to the loads 408. In some examples, the controller 422 may control the power-distribution circuitry 420 to transfer an input-power connection between the two power sources 402, 404 in an open-transition configuration. Accordingly, the power-distribution system 406 may rectify AC power to DC power upstream of the loads 408 such that DC power is provided to the loads 408.

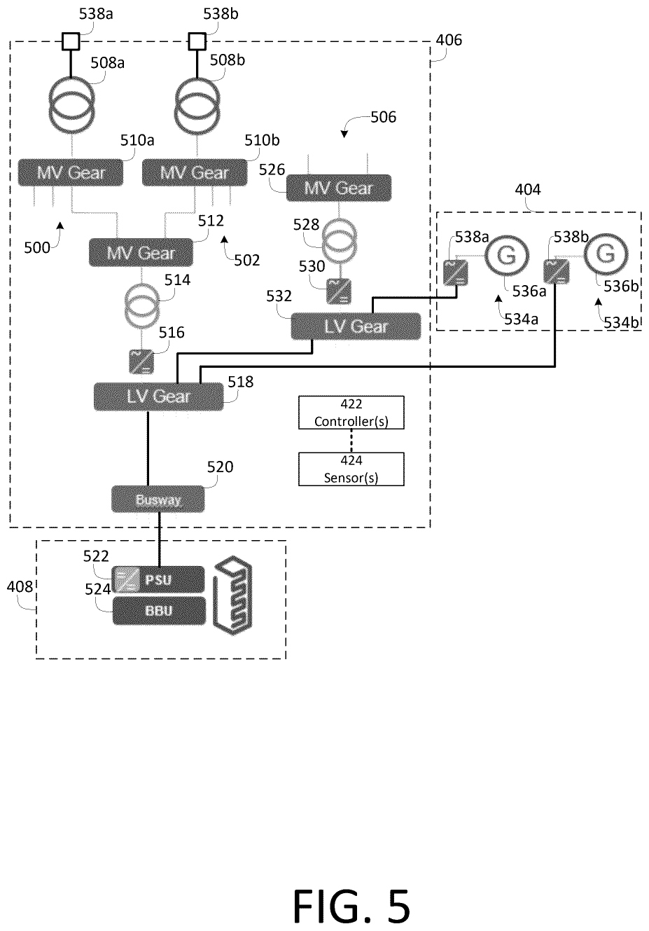

FIG. 5 illustrates a schematic diagram of the power-distribution system 406 according to an example. FIG. 5 illustrates a redundant scheme in which multiple primary power sources and multiple secondary power sources provide power to the power-distribution system 406. FIG. 5 illustrates an example of the secondary power sources 404, which includes multiple DC gensets. The primary power sources 402 are not illustrated for clarity, but may include AC utility grids.

The power-distribution system 406 includes a main power path 500 and a redundant power path 502. The power-distribution system 406 may normally route power through the main power path 500. However, the power-distribution system 406 may route power through the redundant power path 502 if, for example, a component in the main power path 500 fails and needs to be replaced, needs to be maintained, needs to be upgraded, and so forth. The power-distribution system 406 may be configured in a catcher redundancy configuration and may therefore include a redundant catcher path 506, also referred to as a catcher redundancy system, as well.

The main power path 500 includes a high-to-medium-voltage transformer 508a (“high-voltage transformer 508a) and a medium-voltage switchgear 510a. The redundant power path 502 includes a high-to-medium-voltage transformer 508b (“high-voltage transformer 508b”) and a medium-voltage switchgear 510b. The power paths 500, 502 feed into a common medium-voltage switchgear 512, a medium-to-low-voltage transformer 514 (“medium-voltage transformer 514”), an AC/DC rectifier 516, a low-voltage switchgear 518, and a busway 520. In some examples, each of the loads 408 includes at least one PSU 522 downstream of the busway 520, and may further include at least one BBU 524. Each PSU 522 may include a respective DC/DC converter.

The redundant catcher path 506 includes a catcher medium-voltage switchgear 526, a catcher medium-to-low-voltage transformer 528, a catcher AC/DC rectifier 530, and a catcher low-voltage switchgear 532. The secondary power sources 404 include at least a first genset 534a and a second genset 534b. The first genset 534a includes a generator 536a and an AC/DC rectifier 538a. The second genset 534b includes a generator 536b and an AC/DC rectifier 538b. In some examples, the gensets 534a, 534b may alternately be referred to as generators, or DC generators, and the generators 536a, 536b may alternately be referred to as alternators, or AC generators. The AC/DC rectifiers 538a, 538b may be examples of the AC/DC rectifiers 410. Each of the AC/DC rectifiers 538a, 538b may include one or more components to rectify AC power to DC power, such as a four-diode-bridge rectifier.

The high-voltage transformer 508a is configured to be coupled to an AC-power source (not illustrated), such as an AC utility grid, at a high-voltage input 538a of the power-distribution system 406, and is coupled to the medium-voltage switchgear 510a. The medium-voltage switchgear 510a is coupled to the high-voltage transformer 508a at a first input connection, and to the common medium-voltage switchgear 512 at an output connection. In some examples, the medium-voltage switchgear 510a may be coupled to one or more additional common branches in a parallel redundant system.

The common medium-voltage switchgear 512 is coupled to the medium-voltage switchgear 510a and the medium-voltage switchgear 510b at respective input connections, and is coupled to the medium-voltage transformer 514 at an output connection. The medium-voltage transformer 514 is coupled to the common medium-voltage switchgear 512 at an input connection and is coupled to the AC/DC rectifier 516 at an output connection. The AC/DC rectifier 516 is coupled to the medium-voltage transformer 514 at an input connection and to the low-voltage switchgear 518 at an output connection.

The low-voltage switchgear 518 is coupled to the AC/DC rectifier 516, the catcher low-voltage switchgear 532, and the second genset 534b at respective input connections, and is coupled to the busway 520 at an output connection. In some examples, the low-voltage switchgear 518 may be coupled to one or more additional busways (not illustrated) at respective output connections. The busway 520 is coupled to the low-voltage switchgear 518 at an input connection, and is coupled to the loads 408 at an output connection. In some examples, the busway 520 includes a plurality of output connections. Each output connection may include or be coupled to a respective DC bus configured to be coupled to a respective load. For example, one output connection may be coupled to the PSU 522, and additional output connections may be coupled to other load PSUs. The PSU 522 is coupled to the busway 520 at an input connection and is coupled to one or more units of IT equipment (for example, one or more server racks) at an output connection. The BBU 524 may also be coupled to the one or more units of IT equipment to provide backup battery power to the IT equipment.

The catcher medium-voltage switchgear 526 may be coupled to one or more power paths at respective input connections, which are omitted for clarity, and may be coupled to the medium-voltage transformer 528 at an output. For example, the catcher medium-voltage switchgear 526 may be coupled to power paths substantially similar or identical to the power paths 500, 502. The catcher medium-voltage transformer 528 is coupled to the catcher medium-voltage switchgear 526 at an input, and is coupled to the catcher AC/DC rectifier 530 at an output. The catcher AC/DC rectifier 530 is coupled to the catcher medium-voltage transformer 528 at an input, and is coupled to the catcher low-voltage switchgear 532 at an output. The catcher low-voltage switchgear 532 is coupled to the catcher AC/DC rectifier 530 at an input, and is coupled to the low-voltage switchgear 518 at an output. In various examples, the catcher low-voltage switchgear 532 may include one or more additional outputs each configured to be coupled to one or more respective low-voltage switchgears similar to the low-voltage switchgear 518.

The first genset 534a is coupled to the catcher low-voltage switchgear 532. More particularly, the generator 536a is coupled to the AC/DC rectifier 538a, and the AC/DC rectifier 538a is coupled to the catcher low-voltage switchgear 532. Similarly, the second genset 534b is coupled to the low-voltage switchgear 518. More particular, the generator 536b is coupled to the AC/DC rectifier 538b, and the AC/DC rectifier 538b is coupled to the low-voltage switchgear 518.

In some examples, the power-distribution system 406 may include or be coupled to the controller 422. The controller 422 is illustrated as a component of the power-distribution system 406 for purposes of example. In other examples, the controller 422 may be external to the power-distribution system 406. In various examples, the controller 422 is coupled to, and configured to control, components of the power-distribution system 406. For example, the controller 422 may control switching operation of the switchgears 510a, 510b, 512, 518, 532, and/or may control the AC/DC rectifiers 516, 530. In some examples, the controller 422 may control the AC/DC rectifiers 538a, 538b. In various examples, the controller 422 controlling the AC/DC rectifiers 538a, 538b may include the controller 422 sending one or more instructions to controllers within the gensets 534a, 534b which, in turn, provide control signals to the AC/DC rectifiers 538a, 538b.

As discussed above, the power-distribution system 406 may include the sensors 424. The sensors 424 may be distributed throughout the power-distribution system 406 and may be coupled to various components. For example, the sensors 424 may include voltage and/or current sensors configured to sense power information at the inputs 538a, 538b.

In operation, the controller 422 may select one of the power paths 500, 502 to deliver power to the loads 408. Power may ordinarily be provided to the loads 408 via the main power path 500. If a component in the main power path 500 needs to be replaced or maintained, then the controller 422 may control components of the power-distribution system 406 to provide power to the loads 408 via the redundant power path 502 instead (and/or the redundant catcher path 506 in some examples). For purposes of explanation, an example is provided in which power is provided via the main power path 500.

The controller 422 may control operation of the power-distribution system 406 based on power information received from the sensors 424. For example, the power information may be indicative of whether acceptable AC power is available at the high-voltage input 538a. In at least one example, the power information may include a voltage at the high-voltage input 538a. The controller 422 may determine whether a voltage level at the high-voltage input 322a is within a range of acceptable voltage values corresponding to acceptable AC power. The controller 422 may be configured to select a mode of operation based on whether acceptable AC power is available. As discussed below, the controller 422 may operate the low-voltage switchgear 518 to derive output DC power from at least one of the high-voltage inputs 538a, 538b to provide to the loads 408 in a first mode of operation. The controller 422 may operate the low-voltage switchgear 518 to derive output DC power from at least one of the gensets 534a, 534b to provide to the loads 408 in a second mode of operation.

If the AC power at the high-voltage input 538a is acceptable, then the controller 422 may control the medium-voltage switchgear 510a to route power received from the AC power source at the high-voltage input 538a from the high-voltage transformer 508a to the medium-voltage switchgear 512. If components of the main power path 500 need to be maintained, replaced, or otherwise switched out, then power may instead be drawn from the redundant power path 502. If power is to be drawn from the redundant power path 502 and the AC power at the high-voltage input 538b is acceptable, then the controller 422 may control the medium-voltage switchgear 510b to route power received from the AC power source at the high-voltage input 538b from the high-voltage transformer 508b to the medium-voltage switchgear 512.

The controller 522 controls the medium-voltage switchgear 512 to route AC power received from either the main power path 500 or the redundant power path 502 to the medium-voltage transformer 514. The medium-voltage transformer 514 steps down the AC power received from the medium-voltage switchgear 512 from a medium voltage to a low voltage, and provides the stepped-down power to the AC/DC rectifier 516. The controller 422 controls the AC/DC rectifier 516 to rectify the received AC power to DC power and provide the DC power to the low-voltage switchgear 518.

In some examples, the redundant catcher path 506 may provide redundant power to the low-voltage switchgear 518 if both of the power paths 500, 502 fail or are otherwise unavailable to route power. The controller 422 may control the catcher medium-voltage switchgear 526 to route power from a selected input connection (which may, in turn, be coupled to a power path similar to the power paths 500, 502) to the catcher medium-voltage transformer 528. The catcher medium-voltage transformer 528 steps the received power down from a medium voltage to a low voltage and provides the low-voltage AC power to the catcher AC/DC rectifier 530. The controller 422 controls the catcher AC/DC rectifier 530 to convert the received AC power to DC power and provide the DC power to the catcher low-voltage switchgear 532. The controller 422 controls the catcher low-voltage switchgear 532 to provide power derived from the catcher AC/DC rectifier 530 to the low-voltage switchgear 518.

If acceptable AC power is not available at the high-voltage inputs 538a, 538b or at the catcher medium-voltage switchgear 526, then the controller 422 may control the low-voltage switchgear 518 to route power from the secondary power sources 404 to the busway 518. The low-voltage switchgear 518 may receive backup power from the secondary power sources 404 either directly from the second genset 534b, or indirectly from the first genset 534a via the catcher low-voltage switchgear 532. The busway 520 distributes the DC power received from the low-voltage switchgear 518 to the loads 408.

Accordingly, the power-distribution system 406 may receive power at the high-voltage inputs 538a, 538b and/or from the secondary power sources 404, and may provide power to the loads 408. In various examples, the power-distribution system 406 receives AC power from the inputs 538a, 538b but rectifies the AC power to DC power upstream of the loads 408, and in particular, at the AC/DC rectifier 516. Moreover, the power-distribution system 406 receives DC power from the secondary power sources 404. The power-distribution system 406 may therefore provide DC power to the loads 408, and the loads 408 may not need to implement AC/DC rectifiers at the load level. In various examples, the loads 408 may include IT equipment, such that the power-distribution system 406 provides output DC power to the IT equipment.

As discussed above, in some examples, the gensets 534a, 534b may include AC/DC rectifiers 538a, 538b and may provide DC power to the power-distribution system 406. In other examples, the power-distribution system 406, rather than the gensets 534a, 534b, may include the AC/DC rectifiers 538a, 538b. For example, the AC/DC rectifiers 538a, 538b may be coupled to and upstream of the catcher low-voltage switchgear 532 and the low-voltage switchgear 518, respectively, within the power-distribution system 406. Accordingly, in various examples the low-voltage switchgears 532, 518 may be coupled to, and may be configured to receive input DC power from, the generators 536a, 536b, whether the gensets 534a, 534b or the power-distribution system 406 includes the AC/DC rectifiers 538a, 538b.

As discussed above, in some examples, power may be provided via the redundant catcher path 506 if acceptable power is unavailable at the high-voltage inputs 538a, 538b, and power may be provided via the secondary power sources 404 if acceptable power is unavailable from the redundant catcher path 506. In other examples, power may be provided via the secondary power sources 404 if acceptable power is unavailable from the high-voltage inputs 538a, 538b, and power may be provided via the redundant catcher path 506 if acceptable power is unavailable from the secondary power sources 404.

Various controllers, such as the controllers 220, 422, may execute various operations discussed above. The controllers 220, 422 may be or include one or more hardware components and may be or include processing circuitry. The controllers 220, 422 may also execute one or more instructions stored on one or more non-transitory computer-readable media, which the controllers 220, 422 may include and/or be coupled to, which may result in manipulated data. The one or more non-transitory computer-readable media may be or include hardware devices. The non-transitory computer-readable media may include memory and/or storage hardware. In some examples, the controllers 220, 422 may include one or more processors or other types of controllers. In one example, the controllers 220, 422 are or includes at least one processor. Example processors may include hardware components such as microprocessors. In another example, the controllers 220, 422 perform at least a portion of the operations discussed above using an application-specific integrated circuit tailored to perform particular operations in addition to, or in lieu of, a processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above. The computer-program product may be, or include, at least one hardware component configured to store and/or execute at least one computer program, and may be or include processing circuitry.

As noted above, in some examples, the power-distribution system 100 may include primary power sources 102, secondary power sources 104, and alternate power sources 110. In some examples, the primary power sources 102 may include AC power sources, such as a utility grid, the secondary power sources 104 may include backup power sources, such as generators, and the alternate power sources 110 may include other power sources, such as fuel cells, photovoltaics, and so forth. In other examples, the primary power sources 102 may include a primary AC power source (for example, an AC grid that provides power to the switchgears 510a, 510b), the secondary power sources 104 may include a backup AC power source (for example, an AC grid that provides power to the redundant catcher path 506, and the alternate power sources 110 may include backup power sources, such as generators (for example, the gensets 534a, 534b) and, optionally, one or more other power sources, such as fuel cells, photovoltaics, and so forth. Accordingly, the principles of the disclosure are not intended to be limited by whether a power source is indicated as a primary power source, a secondary power source, or an alternate power source.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A power-distribution system, comprising:
a high-voltage input;
a high-to-medium voltage transformer coupled to the high-voltage input;
a medium-to-low voltage transformer coupled to the high-to-medium voltage transformer;
a generator;
a low-voltage switchgear coupled to the generator, the low-voltage switchgear being configured to receive input DC power derived from the generator and to output DC power to information technology (IT) equipment; and
a first AC-DC converter coupled between the medium-to-low voltage transformer and the low-voltage switchgear.

2. The power-distribution system of claim 1, wherein the low-voltage switchgear is configured to derive the output DC power from the high-voltage input.

3. The power-distribution system of claim 1, wherein the generator includes a second AC-DC converter.

4. The power-distribution system of claim 3, wherein the DC generator further comprises an AC generator coupled to the second AC-DC converter.

5. The power-distribution system of claim 3, wherein the second AC-DC converter is a four-diode bridge rectifier.

6. The power-distribution system of claim 1, further comprising a medium-voltage switchgear coupled between the high-to-medium voltage transformer and the medium-to-low voltage transformer.

7. The power-distribution system of claim 6, further comprising:
a second high-voltage input;
a second high-to-medium voltage transformer; and
a second medium-voltage switchgear coupled between the second high-voltage input and the medium-to-low voltage transformer.

8. The power-distribution system of claim 7, further comprising a third medium-voltage switchgear coupled to the first medium-voltage switchgear, the second medium-voltage switchgear, and the medium-to-low voltage transformer.

9. The power-distribution system of claim 1, wherein the low-voltage switchgear is configured to be coupled to one or more alternate DC power sources.

10. The power-distribution system of claim 9, wherein the one or more alternate DC power sources include a renewable power source.

11. The power-distribution system of claim 1, further comprising a catcher redundancy system, the catcher redundancy system including:
a second medium-to-low voltage transformer;
a third AC-DC converter coupled between the second medium-to-low voltage transformer and the low-voltage switchgear; and
a second DC generator including a fourth AC-DC converter configured to provide DC power to the low-voltage switchgear.

12. The power-distribution system of claim 11, further comprising a second low-voltage switchgear coupled to the third AC-DC converter, the fourth AC-DC converter, and the first low-voltage switchgear.

13. The power-distribution system of claim 12, wherein the second low-voltage switchgear is configured to be coupled to one or more alternate DC power sources.

14. The power-distribution system of claim 13, wherein the one or more alternate DC power sources include a renewable power source.

15. A power-distribution system, comprising:
a high-voltage input;
a high-to-medium voltage transformer coupled to the high-voltage input;
a medium-to-low voltage transformer coupled to the high-to-medium voltage transformer;
a medium-voltage switchgear coupled between the high-to-medium voltage transformer and the medium-to-low voltage transformer;
a low-voltage switchgear configured to be coupled to a DC generator and to output DC power to information technology (IT) equipment; and
an AC-DC converter coupled between the medium-to-low voltage transformer and the low-voltage switchgear.

16. The power-distribution system of claim 15, further comprising
a second high-voltage input;
a second high-to-medium voltage transformer; and
a second medium-voltage switchgear coupled between the second high-voltage input and the medium-to-low voltage transformer.

17. The power-distribution system of claim 16, further comprising a third medium-voltage switchgear coupled to the first medium-voltage switchgear, the second medium-voltage switchgear, and the medium-to-low voltage transformer.

18. A method of operating a power-distribution system including a high-voltage input, a high-to-medium voltage transformer coupled to the high-voltage input, a medium-to-low voltage transformer coupled to the high-to-medium voltage transformer, a low-voltage switchgear configured to be coupled to a generator and configured to output DC power to information technology (IT) equipment, and a first AC-DC converter coupled between the medium-to-low voltage transformer and the low-voltage switchgear, the method comprising:
operating the low-voltage switchgear to derive output DC power from the high-voltage input to the IT equipment in a first mode of operation; and
operating the low-voltage switchgear to derive output DC power from the generator to the IT equipment in a second mode of operation.

19. The method of claim 18, wherein the power-distribution system further includes a second high-voltage input, a second high-to-medium voltage transformer, and a medium-voltage switchgear coupled to the high-voltage input, the second high-voltage input, and the medium-to-low voltage transformer, and wherein the first mode of operation includes operating the medium-voltage switchgear to derive power from the high-voltage input.

20. The method of claim 19, further comprising operating the medium-voltage switchgear and the low-voltage switchgear to derive output DC power from the second high-voltage input to the IT equipment in a third mode of operation.
